(19) United States
(12) Patent Application Publication
(10) Pub. No.: US 2004/0154998 A1
(43) Pub. Date: Aug. 12, 2004

(54) Ozone purification system for water

(76) Inventor: Charles M. Minnix, Greenwood, IN (US)

Correspondence Address: BAKER & DANIELS, 300 NORTH MERIDIAN STREET, SUITE 2700, INDIANAPOLIS, IN, 46204-1782, US

(21) Appl. No.: 10/628,961

(22) Filed: Jul. 29, 2003

Related U.S. Application Data
(63) Continuation-in-part of application No. 10/207,142, filed on Jul. 29, 2002.

(51) Int. Cl. C02F 1/78

(52) U.S. Cl. 210/760; 210/205

(57) ABSTRACT

An ozone purification system for fluids that includes a pump having an inlet for receiving the fluid. The pump includes at least one opening. An expansion tank is in communication with a first of the at least one opening of the pump, wherein the fluid may flow from the pump through the at least one opening to the expansion tank. The system includes an ozone generator having an ozone impregnator, which is in fluid communication with the expansion tank and is adapted to inject an amount of ozone into the fluid. A holding tank is in communication with the pump. A valve is in communication with the pump and includes a first and a second position. The valve directs the fluid to exit the system when valve is in the first position, and the valve recycles the fluid to the expansion tank when the is in the second position.

This application is a Continuation-in-Part of U.S. application Ser. No. 10/207,142 filed on Jul. 29, 2002.

### BACKGROUND OF THE INVENTION

1. Field of Invention

The present invention relates to water treatment systems, specifically those systems that are used to sterilize and cleanse water.

2. Description of the Related Art

Water is a valuable resource that serves numerous different purposes. Perhaps the most well known use of water is as a beverage for human or animal consumption. In addition, water is essential for bathing and cleaning. Water is also used in beverage and food processing as an ingredient and/or as a cleaning agent for cleansing the ingredients and/or the processing equipment. Water also serves important purposes in medical facilities, pharmacies, and research laboratories. For instance, in medical facilities water is used to cleanse and/or sterilize wounds, burns, surgical equipment, and hospital supplies. In pharmacies, water is used to reconstitute dehydrated medication and prepare medicinal remedies. In research laboratories, water is used to cleanse supplies, prepare solutions, extract compounds, and wash products.

However, raw water often contains pathogens and other microbes that can cause adverse reactions in humans and animals. Consequently, raw water must be cleansed before it can safely serve these purposes. In the case of certain purposes, such as cleansing cuts, scrapes, bums, and the like, the water may also need to be sterilized. Furthermore, raw water typically contains minerals such as iron, which may stain surfaces, skin and hair, and calcium, which forms scale build-up on surfaces. Consequently, some uses require that the water be demineralized before use. Attempts have been made to cleanse water including adding various chemicals to the water to kill pathogens and/or filtering the water to remove pathogens. Unfortunately, these methods often do not cleanse the water to the degree necessary for some uses, such as medicinal and pharmaceutical purposes.

One known chemical method commonly used by municipal utilities includes adding large amounts of chlorine to the water. However, the chlorine may adversely affect the taste of the water, and may also combine with any organic matter present in the water to produce undesirable and potentially dangerous compounds. In addition, the chlorine may cause adverse reactions in people who are sensitive to chemical chlorine. Furthermore, even after chlorination, the water still may still contain a level of microbes that, although deemed safe, may still cause adverse reactions in some people. As a result, some chlorination methods include adding one or more additional chemicals in an attempt to kill the remaining pathogens from the water. However, these attempts are often unsuccessful and can compound the problems associated with chlorination.

Another known method of cleansing water includes impregnating water with ozone (O₃) to assist in killing pathogens and other microbes. Such a system is shown in FIG. 1. In these systems the water is impregnated with ozone, or “ozonated,” and the ozonated water is held in a storage tank until used. Unfortunately, over a period of time the ozone (O₃) breaks down forming O₂, which does not provide the same cleansing effects as ozone. Thus, the stored ozonated water remains effectively ozonated for only a limited period of time. In addition, once the ozone breaks down and the water is no longer considered clean it is generally not used. This results in the generation of a significant amount of waste water. Furthermore, the previous ozone impregnation systems typically use an excess amount of ozone, which may come out of solution during storage of the ozonated water. This excess ozone is usually vented from the system and is neither recovered, nor recycled. Thus, a substantial external supply of ozone is required to impregnate the water, thereby resulting in higher costs and the need for a larger ozone production and storage unit.

Another drawback to previous ozonation systems is that effluent (waste) water is often introduced directly into the ozonation system without preliminary cleansing or filtration. In this case, the ozone is performing more than just the sterilization of the water; it is also cleansing the water. Consequently, the use of such effluent water requires very large quantities of ozone in order to sufficiently clean and maintain a minimum concentration of ozone in the water. Furthermore, the higher the quality of the water introduced into the ozonation system, the higher the quantity of residual ozone remaining in the water. Therefore, the amount of residual ozone in water is greatly reduced in ozonation systems using effluent water because the ozone is being used, not only to sterilize the water but also, to remove all contaminants and minerals. In addition, some of these previous ozonation systems utilize the same tank both for storing the ozonated water and for introducing the effluent water to the ozonation system, thereby quickly contaminating the ozonated water and further reducing the already decreasing ozone level. Thus, the use of effluent water in the previous ozonation systems presents many problems in the sterilization and cleansing of water.

With respect to the demineralization of the water, a common method of removing minerals from the water involves the use of a water softener. Such water softeners remove minerals, such as iron and calcium, but are not capable of sufficiently removing pathogens and other microbes from water.

Therefore, a need remains for a water sterilization system that provides purified water that is free of microbes and other pathogens.

### SUMMARY OF THE INVENTION

The present invention provides an ozone purification system for fluids that includes a pump having an inlet for receiving the fluid. The pump includes at least one opening. An expansion tank is in fluid communication with a first of the at least one opening of the pump, wherein the fluid may flow from the pump through the at least one opening to the expansion tank. The system includes an ozone generator having an ozone impregnator. The impregnator is in fluid communication with the expansion tank and is adapted to inject an amount of ozone into the fluid. A holding tank is in fluid communication with the pump. A valve is in communication with the pump and includes a first and a second position. The valve directs the fluid to exit the system when the valve is in the first position, and the valve recycles the fluid to the expansion tank when the valve is in the second position.

The present invention also provides a method of cleansing a wound including the step of irrigating the wound with ozonated water produced by the system described above.

The present invention further provides a method of processing a food product including the steps of washing the ingredients of the food product with ozonated water produced by the system described above.

The present invention also provides a method of converting rew water to sterilized water, including the steps of:

(a) preliminarily purifying the raw water to produce clean water;

(b) pumping the clean water into an expansion tank;

(c) passing the clean water from the expansion tank to an ozone impregnator;

(d) impregnating the clean water with ozone using the ozone impregnator to produce ozonated water;

(e) transferring the ozonated water into a holding tank;

(f) pumping the ozonated water back to the expansion tank; and

(g) repeating steps (d)-(f) to produce sterilized water and maintain its efficacy.

The present invention further provides an apparatus for sterilizing a food or beverage. The apparatus includes a generator generating a sterilizing agent; a venturi tube havinging a wall defining a passageway adapted to permit a flow of the food or beverage; and a plurality of injector tubes. Each of the injector tubes has a dispensing end, a connecting end, and a channel extending from the dispensing end to the connecting end. The channel is in communication with the passageway through the dispensing end. The connecting end is coupled to the sterilizing agent generator such that the channel receives the sterilizing agent.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a block schematic diagram of a previous single pass ozonation system;

FIG. 2 is a block schematic diagram of the basic operation of the ozone sterilization system for water, in accordance with the present invention;

FIG. 3 a front perspective view of an embodiment of the ozone sterilization system for water utilizing the basic structure of FIG. 2;

FIG. 4 is a top perspective view of the reverse osmosis system of the ozone sterilization system of FIG. 3;

FIG. 5 is an enlarged fragmentary view of a tap and tee of the ozone sterilization system of FIG. 3;

FIG. 6 is an enlarged fragmentary top view of the ozone sterilization system of FIG. 3;

FIG. 7 is a block schematic diagram of the ozone sterilization system of FIG. 3;

FIG. 8 is a flowchart showing the operative steps in the ozone sterilization system in accordance with the present invention;

FIG. 9 is a schematic block diagram of the ozone sterilization system in FIG. 3;

FIG. 10 is a perspective view of one embodiment of a mozzle in accordance with the present invention; and

FIG. 11 is a front view of the nozzle of FIG. 10.

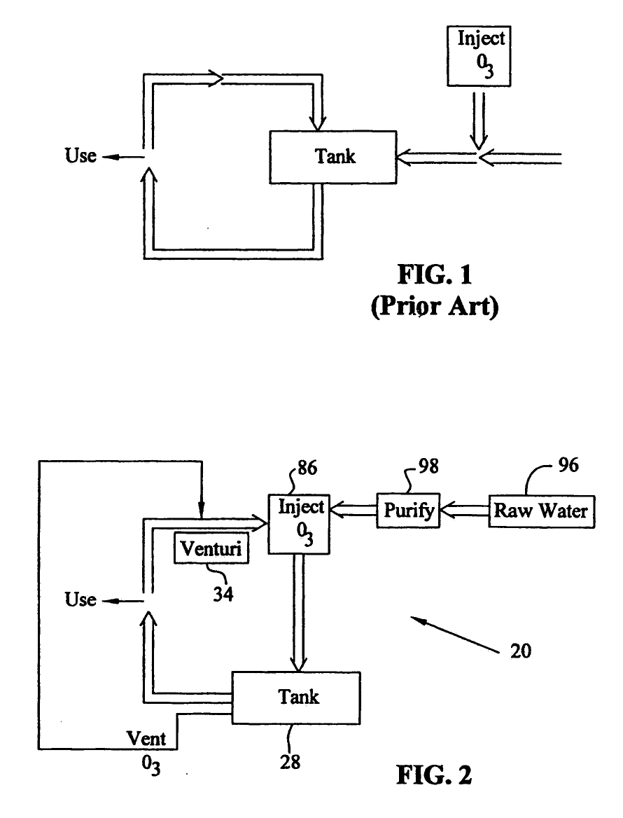

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention and such exemplification is not to be construed as limiting the scope of the invention in any manner.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended.

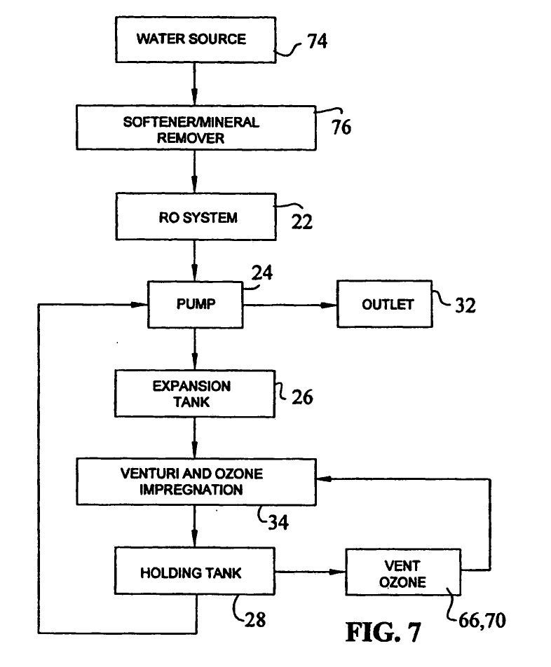

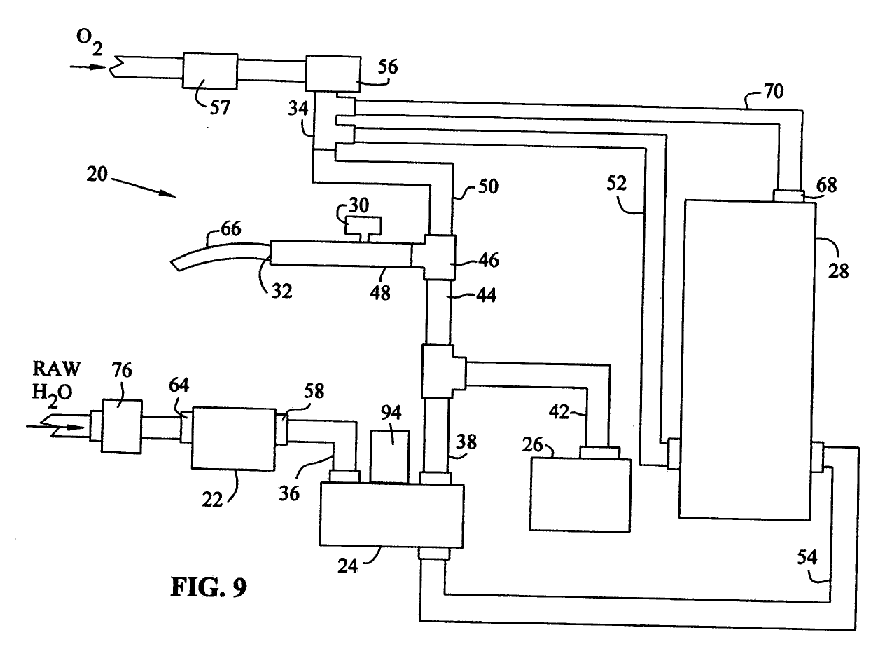

As shown schematically in FIG. 2, the basic operation of ozone purification system 20 begins with receiving raw water 96, such as city water, well water, or even effluent (waste) water. Raw water 96 then undergoes a cleaning process 98, which may include demineralization and filtration by a softener 76 (FIGS. 7 and 9) and/or filtration by a reverse osmosis system 22 (FIGS. 7 and 9). Cleaning process 98 may also include distillation processes, deionization processes, or other purification processes. Since the water is cleaned prior to ozonation, the system of the present invention requires less ozone than systems that directly receive raw water. In addition, the inclusion of cleaning process 98 allows the use of effluent water, while maintaining a rate of ozone injection and retention similar to those ozonation systems utilizing demineralized or clean water.

After cleaning process 98, the cleansed water is injected with ozone 86 and the resulting ozonated water is then sent to holding tank 28. Holding tank 28 may be any known holding tank, such as those manufactured by Wellmate Water Systems, a division of the Pentair Pump Group of Chardon, Ohio. As illustrated in FIG. 2, while awaiting use, the ozonated water in tank 28 is continuously recycled and re-injected with ozone by venturi 34 to maintain a high level of ozone in the water stored in tank 28. Consequently, unlike prior systems, the water in holding tank 28 maintains a greater level of ozonation, due to the recycling and re-injection. Ozone that comes out of the water solution in tank 28 is vented from tank 28 and recycled back to venturi 34 for re-injection into the water. Thus, ozone is not wasted and a smaller, more efficient ozone generator may be used.

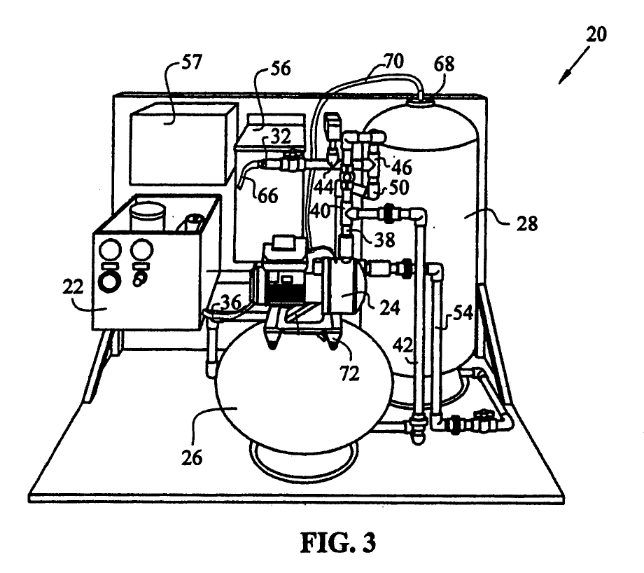

Referring now to FIGS. 3-6 and 9, ozone purification system 20, generally, includes reverse osmosis system 22, pump 24 connected to reverse osmosis system 22, expansion tank 26 connected to pump 24, ozone impregnator/venturi 34 connected to pump 24, ozone generator 56 connected to venturi 34, and holding tank 28 connected to venturi 34 and pump 24.

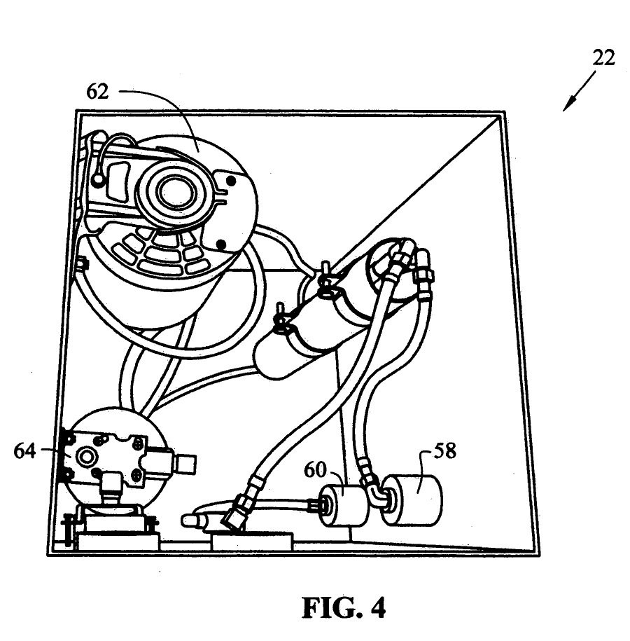

Referring specifically to FIG. 4, reverse osmosis system 22 includes inlet 64 through which water from a water source (not shown) enters system 22. The water source may be a well, a municipal water system, or other raw water source. Alternatively, the water source may be from a softener and/or mineral remover, which provides demineralized water. Inlet 64 is connected to filter 62 wherein the reverse osmosis action occurs and the water is filtered. Reverse osmosis system 22 also includes outlets 58 and 60 through which the filtered water exits system 22. Outlet 60 may be coupled to a monitor (not shown) that senses the quality of the filtered water and recycles the reverse osmosis concentrate. As illustrated in FIGS. 4 and 9, outlet 58 is connected to pump 24 via inlet pipe 36. Reverse osmosis system 22 may be of any known design, such as, for example, the Comro line of reverse osmosis systems manufactured by Force Filtration Systems, Inc. of Venice, Fla.

Although reverse osmosis system 22 is shown as part of purification system 20, it should be noted that a reverse osmosis system is not required for operation of system 20. Alternative methods of, and systems for, cleansing the raw water may be utilized in place of reverse osmosis system 22, provided that the water is purified to a significantly clean level. For example, a separate ozone based water cleaning system could be used as the cleaning system for supplying sufficiently clean water to purification system 20. Distillation systems and/or demineralization systems may also be used.

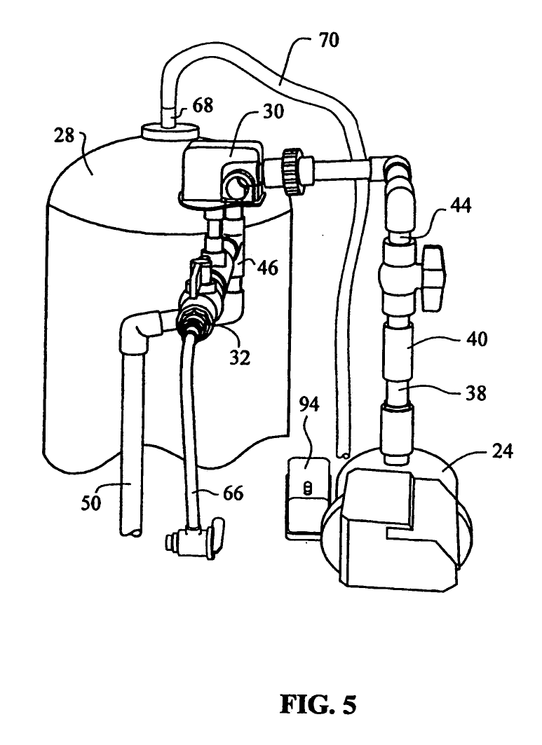

Referring now to FIGS. 3, 6 and 9, outlet 58 of reverse osmosis system 22 is connected to pump 24 via inlet pipe 36. Pump 24 may be of a known type, such as those manufactured by Grundfos Management A/S of Bjerringbro, Denmark. Pump 24 includes a first opening and a second opening. The first opening of pump 24 is connected via two-way pipe 38 to tee 40. Tee 40 is connected to expansion tank 26 via two-way pipe 42. Expansion tank 26 may also be of a known type, such as those manufactured by Wellmate Water Systems, a division of the Pentair Pump Group of Chardon, Ohio. Expansion tank 26 is attached to and supports pump 24 by brackets 72. Expansion tank 26 is connected to venturi 34 via pipe 42, tee 40, pipe 44, tee 46, and pipe 50. As shown in FIGS. 5 and 9, a pressure switch, or pressure sensor, 94 is attached to pump 24 and monitors the pressure within the system.

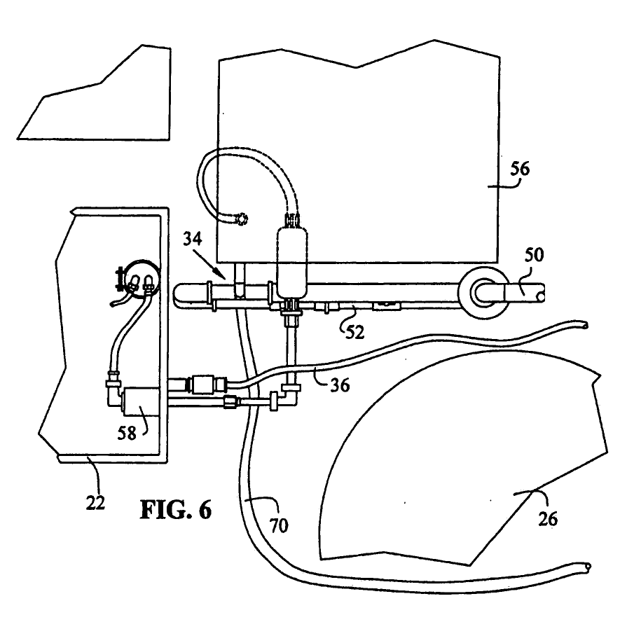

Turning specifically to FIGS. 6 and 9, venturi 34 may include, or may be connected to an ozone sensor (not separately shown), which monitors the ozone level of the water. Venturi 34 is connected to ozone generator 56, which may be a conventional type such as, for example, those manufactured by Ozotech of Yreka, Calif. Ozone generator 56 is connected to dryer 57, which may be any known dryer including those manufactured by the Ozone Division of Net Systems Inc. of Japan. Venturi 34 is also connected to holding tank 28 via pipe 52 and via tube 70. Holding tank 28 includes vent 68, which communicates between tank 28 and tube 70. Holding tank 28 is also connected to pump 24 via pipe 54. Referring to FIGS. 5 and 9, tap 32 is connected to tee 46 via pipe 48 such that there is a direct connection between pump 24 and outlet 32 via pipe 38, tee 40, pipe 44, tee 46 and pipe 48. Tap 32 is connected to outlet tube 66, which may be used to facilitate the drawing of the ozonated water from system 20. Pressure switch 30 is linked to pipe 48 and monitors the pressure within pipe 48, tap 32 and outlet tube 66. Pressure switch 30 is coupled to a valve (associated with pump 24) that moves between a first position and a second position to direct the flow of water, as is described in further detail below. The valve may be connected to, or a component of, pump 24.

Referring to FIGS. 7 and 9, the operation of system 20 will now be described in further detail. First, raw (unpurified) water from water source 74 passes through softener 76 where minerals are filtered from the water. The demineralized water then enters reverse osmosis system 22 through inlet 64, where the water is further filtered and demineralized. The filtered, but unsterilized water, exits reverse osmosis system 22 through outlet 58 and flows through inlet pipe 36 to pump 24. Pump 24 then pumps the unsterilized water to expansion tank 26 via pipe 38, tee 40 and pipe 42.

In the meantime, sensor 94 is monitoring the pressure within the system. When the system pressure indicates that the water level (pressure) within expansion tank 26 has reached or exceeded a predetermined level and that holding tank 28 is not full, sensor 94 permits the unsterilized water to flow from expansion tank 26 to venturi 34. In flowing from expansion tank 26 to venturi 34, the unsterilized water travels through pipe 42, tee 40, pipe 44, tee 46 and pipe 50.

Meanwhile, oxygen (O₂) enters dryer 57 where it is dried in preparation for conversion to ozone (O₃). The dried oxygen (O₂) flows to ozone generator 56, which produces ozone (O₃) from the dried oxygen (O₂). The amount of ozone generated may be adjusted according to the amount of ozone sensed in the water. The ozone is then passed to venturi 34, which injects the unsterilized water with the ozone to produce ozonated (sterile) water. The ozonated water then flows from venturi 34 to holding tank 38 via pipe 52. The ozonated water is drawn from holding tank 28 back to pump 24 via pipe 54, and is either recirculated to venturi 34 for super-impregnation of ozone, or released to tap 32.

Meanwhile, pressure sensor 30 monitors the pressure within pipe 48, tap 32, and outlet tube 66. When the pressure indicates that a demand has been made for ozonated water, pressure sensor 30 triggers the valve to move to the first position, which allows the ozonated water to flow from pump 24 through pipe 38, tee 40, pipe 44, tee 46, pipe 48, tap 32 and out outlet tube 66. If no demand has been made, pressure sensor 30 triggers the valve to move to the second position, which restricts flow to outlet tube 66. In this case, the ozonated water recirculates through pipe 38, tee 40, pipe 42 to expansion tank 26. From expansion tank 26 the ozonated water returns to venturi 34 via tube 42, tee 40, tube 44, tee 46 and tube 50 for reimpregnation or superimpregnation with ozone. The resulting super-ozonated water returns to holding tank 28 via pipe 52. This cycling and superimpregnation of the water occurs periodically or continuously until water demand is sensed by pressure switch 30. This recycling results in water having and maintaining high levels of ozone. The highly purified water, which has undergone the ozone impregnation process, is capable of being used in any application requiring clean and sterilized water.

While stored in holding tank 28, excess ozone may come out of the ozonated water solution. In this event, the excess ozone is vented through vent 68 and flows through tube 70 to venturi 34. The excess ozone then is used to ozonate water, rather than being vented to the ambient air surrounding ozone sterilization system 20. This recycling of ozone minimizes the waste of ozone and allows for the use of a smaller, more efficient ozone generator.

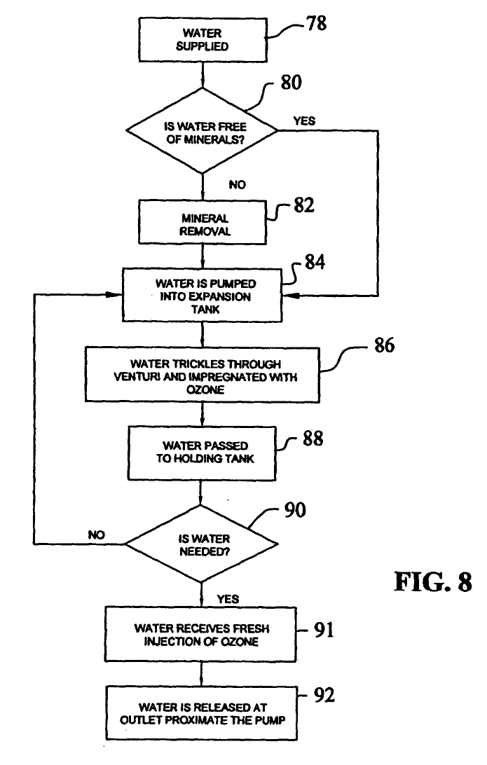

The operation of an ozone purification system according to another embodiment will now be described with reference to the schematic diagram in FIG. 8. At block 78, water is supplied to system from a water source. Next, a determination is made as to whether or not the water has already been demineralized (block 80). If the water has not been demineralized, then the water passes through a mineral removal process (block 82), which may be performed by a softener, a reverse osmosis system, and/or other demineralization mechanism. If the water is free of minerals, then the water is pumped into an expansion tank (block 84). After passing into the expansion tank, the water passes through a venturi where the water is impregnated with ozone (block 86). The resulting ozonated water is then passed to a holding tank 28 (block 88).

After the water is passed to the holding tank, the system determines whether ozonated water has been demanded at the tap. If ozonated water has been demanded, then the water is released, as described above and indicated at block 92. Just prior to the release of water, the water receives a fresh injection of ozone (block 91). If ozonated water is not demanded at the tap, the ozonated water is pumped back into the expansion tank (block 84) and then trickles through the venturi, where it is again impregnated with ozone (block 86). The water is again passed to the holding tank (block 88), and the cycle is repeated. Thus, the water circulating through the system is impregnated with ozone multiple times, thereby creating super-impregnated water and maintaining a predetermined concentration of ozone in the water.

As noted above, the highly purified water produced by systems of this invention, is capable of being used in any application requiring clean and/or sterilized water. For instance, the purified water produced by systems of this invention may be used for human or animal consumption. The highly purified water may be used medicinally to cleanse wounds, equipment, or supplies. The water may also be used in food processing to clean the equipment or ingredients. It may also be used as an ingredient or supplement in food or beverage processing.

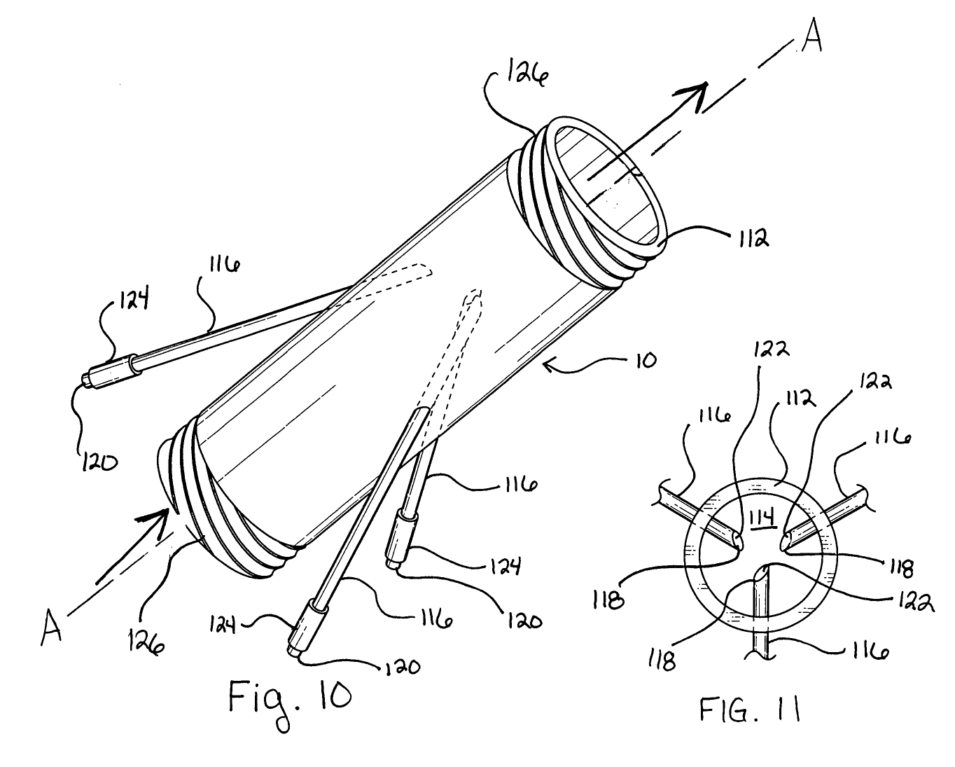

Referring now to FIGS. 10 and 11, when used in food processing and other applications, system 20 may include venturi tube 110. Venturi tube 110 serves to inject ozone or other sterilization agent into a fluid stream to produce a purified fluid stream, creating an ozonated fluid. Venturi tube 110 includes substantially cylindrical wall 112, which defines passageway 114. A plurality of injector tubes 116 extend through wall 112 and into passageway 114. Each injector tube 116 includes dispensing end 118, connecting end 120, and channel 122 extending from dispensing end 118 to connecting end 120. Dispensing end 118 protrudes into passageway 114 and connecting end 120 connects to a sterilizing agent generator, such as ozone generator 56 (FIG. 3), such that passageway 114 is in communication with a sterilizing agent generator through channel 122. A check valve 124 may be positioned in channel 122 at connecting end 120 to control the flow of ozone into passageway 114 and prevent flow from entering ozone generator 56. The ends 126 of venturi tube 110 may be threaded for connection to other food processing components and equipment.

In operation, the food or beverage flows down passageway 114 of venturi tube 110 in the direction of the arrow. As the food or beverage flows pass dispensing end 118 of injector tubes 116, a sterilizing agent is injected into the food or beverage. The sterilizing agent may be ozone. Alternatively, the food or beverage may be injected with ozonated water from ozone purification system 20, in which case connecting end 120 of injector tubes 116 are connected to outlet 66 of ozone purification system 20 (FIG. 2). In another alternative, the food or beverage may be injected with hydrogen peroxide, in which case connecting end 120 of injector tubes 116 is connected to a source of hydrogen peroxide.

Although venturi tube 110 is shown as having a substantially cylindrical shape, it should be understood that the venturi tube of the present invention may have a variety of different shapes and designs. In addition, venturi tube 110 may vary in size depending on the application in which the water is used. For example, in processing foods such as salsa, sauces or other like foods, passageway 114 of nozzle 110 may have a diameter of about 1 ¼ inch (3.175 cm) to about 1 ½ inch (3.81 cm). In addition, injector tubes 116 are positioned at an angle α of between about 45° to about 75°, and preferably at about 65° relative to axis A of venturi tube 110. This positioning of injector tubes 116 minimizes the disruption in the food processing, because the ozone or ozonated water is injected quickly and in the direction of the flow of the food. Thus the flow of the food is not significantly reduced or blocked by the ozone or ozonated water entering passageway 114 from dispensing end 118 of injector tubes 116.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An ozone purification system for water comprising:
a pump having an inlet for receiving the water, said pump including at least one opening;
an expansion tank in fluid communication with a first of said at least one opening of said pump, wherein the water may flow from said pump through said at least one opening to said expansion tank;
an ozone generator having an ozone impregnator, said impregnator in fluid communication with said expansion tank and adapted to inject an amount of ozone into the water;
a holding tank in fluid communication with said pump; and
a valve in communication with said pump and having a first and a second position, said valve directing the water to exit the system when said valve is in said first position, and said valve recycling the water to said expansion tank when said valve is in said second position.

2. The system of claim 1, wherein when said valve is in said second position, the water flows from said expansion tank to said ozone impregnator.

3. The system of claim 1, further comprising an ozone sensor, said ozone sensor detecting a level of ozone in the water.

4. The system of claim 3, wherein said sensor adjusts said amount of ozone injected into water based upon said level of ozone in the water.

5. The system of claim 3, wherein said ozone sensor is a component of said ozone impregnator.

6. The system of claim 1, further comprising a water purification device coupled to said inlet of said pump.

7. The system of claim 6, wherein said water purification device is a reverse osmosis system.

8. The system of claim 6, wherein said water purification device includes an inlet for receiving the water, and wherein the system of claim 6 further comprises a water softener device coupled to said inlet of said water purification device.

9. The system of claim 1, wherein said holding tank includes a vent, said vent in fluid communication with said ozone impregnator.

10. The system of claim 1 further comprising an outlet tube in communication with said pump, the water exiting the system through said outlet tube when said valve is in the first position.

11. The system of claim 10, further comprising a venturi tube defining a passageway and having a plurality of injector tubes extending from said passageway at an angle of between about 45° and about 75° relative to said passageway, each of said plurality of injector tubes defining a channel in communication with said passageway.

12. The system of claim 11, wherein said channel is in communication with said outlet tube.

13. The system of claim 11 wherein said channel is in communication with said ozone generator.

14. The system of claim 11, wherein said passageway has a diameter of between about 1 ¼ inches (3.175 cm) to about 1 ½ inches (3.81 cm).

15. The system of claim 10, further comprising a pressure sensor in communication with said outlet tube, said pressure sensor sensing a demand at said outlet tube and directing said valve to move from said second position to said first position when said demand is sensed.

16. The system of claim 1 further comprising a dryer in communication with said ozone generator, said dryer receiving oxygen and producing dried oxygen, said dried oxygen flowing to said ozone generator.

17. The system of claim 1, wherein said holding tank is in fluid communication with said pump through a second of said at least one opening.

18. A method of cleansing a wound including the step of irrigating the wound with ozonated water produced by the system of claim 1.

19. A method of processing a food product including the steps of washing the ingredients of the food product with ozonated water produced by the system of claim 13.

20. A method of converting raw water to sterilized water, comprising the steps of:
(a) treating the raw water to produce clean water;
(b) pumping the clean water into an expansion tank;
(c) passing the clean water from the expansion tank to an ozone impregnator;
(d) impregnating the clean water with ozone using the ozone impregnator to produce ozonated water;
(e) transferring the ozonated water into a holding tank;
(f) pumping the ozonated water back to the expansion tank; and
(g) repeating steps (d)-(f) to produce sterilized water.

21. The method of claim 20 further comprising recycling excess ozone from the holding tank to ozone impregnator.

22. The method of claim 21, wherein steps (d)-(f) are continuously repeated to maintain the ozone level in the sterilized water.

23. The method of claim 20 further comprising, after passing the ozone impregnated water into a holding tank:
determining whether there is a demand for sterilized water from an outside demand source;
pumping the sterilized water to an outlet in communication with the outside demand source.

24. The method of claim 20, wherein said step of treating water includes filtering water through a reverse osmosis system.

25. The method of claim 24, wherein said step of treating water further includes demineralizing water in a softener system.

26. A water purification system comprising:
an impregnator capable of impregnating water with ozone;
a storage tank connected to said impregnator and capable of holding a volume of water;
a circulator coupling said impregnator and said storage tank, said circulator adapted to move water from said storage tank to said impregnator for further impregnation of ozone in the water before re-entry to storage tank.

27. The system of claim 26 further comprising an expansion tank coupled to said circulator.

28. The system of claim 27 further including a sensor adapted to sense the pressure within the system, said sensor communicating with said circulator to move water in response to system pressure.

29. The system of claim 26 further comprising an outlet coupled to said circulator.

30. The system of claim 26 further comprising a cleaning system connected to said circulator and adapted to clean water before it enters the circulator.

31. An apparatus for sterilizing a food or beverage comprising:
a generator generating a sterilizing agent;
a venturi tube including a wall defining a passageway adapted to permit a flow of the food or beverage;
a plurality of injector tubes having a dispensing end, a connecting end, and a channel extending from said dispensing end to said connecting end, said channel in communication with said passageway through said dispensing end, said connecting end coupled to said sterilizing agent generator such that said channel receives said sterilizing agent.

32. The apparatus of claim 31 wherein said generator is an ozone generator and said sterilizing agent is ozone.

33. The apparatus of claim 31 wherein said generator is an ozone purification system and said sterilizing agent is ozonated water.

32. The apparatus of claim 31 further comprising a check valve disposed within said channel at said connecting end.

33. The apparatus of claim 31 wherein said passageway has a diameter of about 1 ¼ inch (3.175 cm) to about ½ inch (3.81 cm).

34. The apparatus of claim 31 wherein each of said plurality of injector tubes are positioned at an angle of between about 45° to about 75° to an axis said passageway.

35. The apparatus of claim 33 wherein said ozone purification system includes
a pump having an inlet for receiving water, said pump including at least one opening;
an expansion tank in fluid communication with a first of said at least one opening of said pump, wherein the water may flow from said pump through said at least one opening to said expansion tank;
an ozone generator having an ozone impregnator, said impregnator in fluid communication with said expansion tank and adapted to inject an amount of ozone into the water;
a holding tank in fluid communication with said pump; and
a valve in communication with said pump and having a first and a second position, said valve directing the water to exit the system when said valve is in said first position, and said valve recycling the water to said expansion tank when said valve is in said second position.
